(19) United States
(12) Patent Application Publication
(10) Pub. No.: US 2005/0241476 A1
(43) Pub. Date: Nov. 3, 2005

(54) Contaminant removal device

(75) Inventor: Peter Gilbert Mackie, New Norcia WA (AU)

Correspondence Address: FISH & RICHARDSON PC, P.O. BOX 1022, MINNEAPOLIS, MN, 55440-1022, US

(73) Assignee: MACKIE INTERNATIONAL PTY LTD

(21) Appl. No.: 11/119,661

(22) Filed: May 2, 2005

(30) Foreign Application Priority Data
May 3, 2004 (AU) 2004902289

(51) Int. Cl. B01D 51/08

(52) U.S. Cl. 95/32

(57) ABSTRACT

A contaminant removal device (10) is disclosed for removing contaminants from contaminant laden target material when the contaminants are more dense than the target material. The device (10) includes gas ejecting means (18, 20) for ejecting a current of gas in an upwardly and forwardly direction, and means (14) for causing contaminant laden target material to traverse the current of gas during use. The gas ejecting means (18, 20) is arranged such that a substantial proportion of the target material is moved forwardly by the gas ejecting means (18, 20) to be disposed above a first location, and such that a substantial proportion of the contaminants does not move sufficiently forwardly to be disposed above the first location and falls downwardly towards a second location under action of gravity.

### FIELD OF THE INVENTION

The present invention relates to a contaminant removal device for removing contaminants from contaminant laden target material when the contaminants are generally more dense than the target material. The invention is particularly suitable for separating contaminants from relatively loose fibrous material such as hay.

### BACKGROUND OF THE INVENTION

In the agricultural industry, it is common for contaminants to become incorporated into plant material as the plant material is harvested and handled and in some cases for the plant material to become laden with relatively large contaminant material. This is undesirable to both the provider and the receiver of the target material.

### SUMMARY OF THE INVENTION

In accordance with an aspect of the present invention, there is provided a contaminant removal device for removing contaminants from contaminant laden target material when the contaminants are more dense than the target material, said device including:
a gas ejecting device for ejecting a current of gas in an upwardly and forwardly direction; and
means for causing contaminant laden target material to traverse the current of gas during use;
said gas ejecting device being arranged such that a substantial proportion of the target material is moved forwardly by said gas ejecting device to be disposed above a first location, and such that a substantial proportion of the contaminants does not move sufficiently forwardly to be disposed above the first location and falls downwardly towards a second location under action of gravity.

Preferably, the gas ejecting device includes at least one nozzle connectable, in use, to a source of gas and preferably a source of air. The or each nozzle may include one outlet aperture. One or more of the nozzles may include two or more outlet apertures. Each outlet aperture may be of generally elongate configuration with the outlet apertures disposed so as to extend in a direction generally perpendicular to the direction of travel of contaminant laden material during use.

In an arrangement which includes a plurality of nozzles, the nozzles may be arranged such that air ejected from the nozzles travels in directions centered along lines extending at angles to vertical which increase with each successive nozzle.

In an arrangement which includes a plurality of nozzles, the nozzles may be disposed such that the or each output aperture of each nozzle is lower than the or each output aperture of a preceding nozzle. The outlet apertures of the first, second and third nozzles may be located such that a line passing through the outlet apertures subtends an angle of approximately 30° to horizontal.

In one arrangement, the means for causing the contaminant laden target material to traverse the current of gas during use comprises a conveyor belt.

In one embodiment, two nozzles are provided with each nozzle having one outlet aperture.

In an alternative embodiment, three nozzles are provided, a first nozzle having two outlet apertures, with the first nozzle and the two outlet apertures of the first nozzle being arranged such that air ejected from the first nozzle travels in directions centred along lines extending approximately 10° and 20° respectively from vertical, a second nozzle having two outlet apertures with the second nozzle and the two outlet apertures of the second nozzle being arranged such that air is ejected from the second nozzle in directions centred along lines extending approximately 15° and 25° respectively from vertical, and a third nozzle having one outlet aperture with the third nozzle and the outlet aperture of the third nozzle being arranged such that air is ejected from the third nozzle in a direction centred along a line extending approximately 30° from vertical.

The or each nozzle may be configured such that a nozzle chamber is defined for transferring gas between a gas source and the or each outlet aperture of the nozzle, the chamber reducing in cross-sectional area between the gas source and the or each outlet aperture. The configuration of the or each nozzle may be such that the or each nozzle is generally arcuate or teardrop shaped in cross-section.

In one embodiment, the device includes a housing in which the gas ejecting device is disposed. The housing may include a first outlet 34 disposed generally below the first location and a second outlet disposed generally below the second location.

Preferably, the housing is configured such that during use the size of the housing is sufficiently large to minimise turbulence in the housing. The housing may be arranged such that the cross-sectional size of the housing increases towards an upper wall of the housing.

Preferably, the device further includes a conduit connecting an upper portion of the housing to a region of the housing generally below the or each nozzle so as to thereby minimise generation of a pressure differential between a region of the housing generally above the or each nozzle and the region of the housing generally below the or each nozzle. The device may further include means for drawing gas through the conduit from the upper portion of the housing to the region of the housing generally below the or each nozzle. The means for drawing gas may include a fan.

The device may further include a second conveyor disposed in the housing for conveying target material to the second outlet.

The device may further include a plurality of fingers arranged so as to restrict any relatively large target material from falling downwardly towards the second outlet.

In accordance with a second aspect of the present invention, there is provided a method of removing contaminants from contaminant laden material when the contaminants are more dense than the target material, said method including the steps of:
ejecting a current of gas in an upwardly and forwardly direction; and
causing contaminant laden target material to traverse the current of gas;
the step of effecting movement of contaminant laden target material causing a substantial portion of the target material to move forwardly to be disposed above a first location and causing a substantial proportion of the contaminants to not move sufficiently forwardly to be disposed above the first location and to fall downwardly towards a second location under action of gravity.

### BRIEF DESCRIPTION OF THE DRAWINGS

The present invention will now be described, by way of example only, with reference to the accompanying drawings, in which:

FIG. 1 is a diagrammatic cross-sectional side view of a contaminant removal device in accordance with an embodiment of the present invention;

FIG. 2 is a diagrammatic cross-sectional view of the contaminant removal device taken along the line II-II in FIG. 1 in the direction of the arrows;

FIG. 3 is a diagrammatic perspective view of a nozzle of the contaminant removal device shown in FIGS. 1 and 2;

FIG. 4 is a diagrammatic perspective view of an alternative nozzle of the contaminant removal device shown in FIGS. 1 and 2;

FIG. 5 is an enlarged view of a nozzle arrangement of the contaminant removal device shown in FIGS. 1 and 2; and

FIG. 6 is a diagrammatic representation of a nozzle arrangement of an alternative contaminant removal device in accordance with an alternative embodiment of the present invention.

### DESCRIPTION OF AN EMBODIMENT OF THE INVENTION

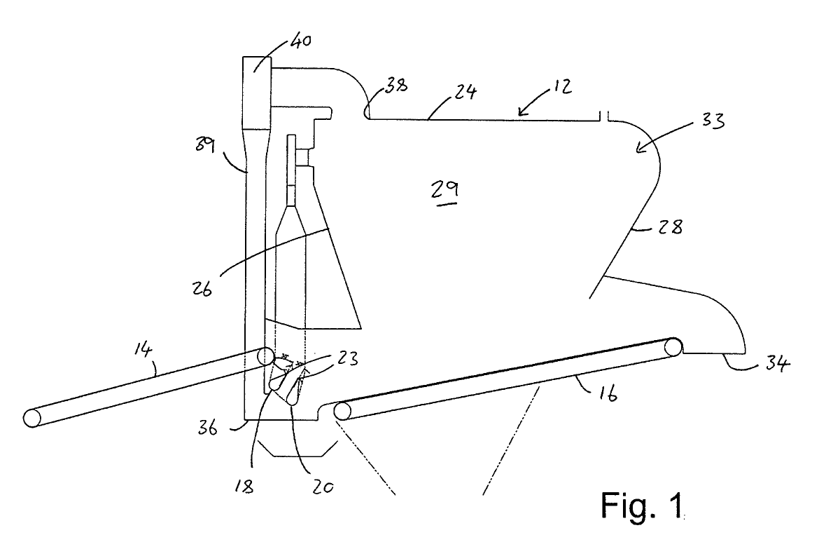

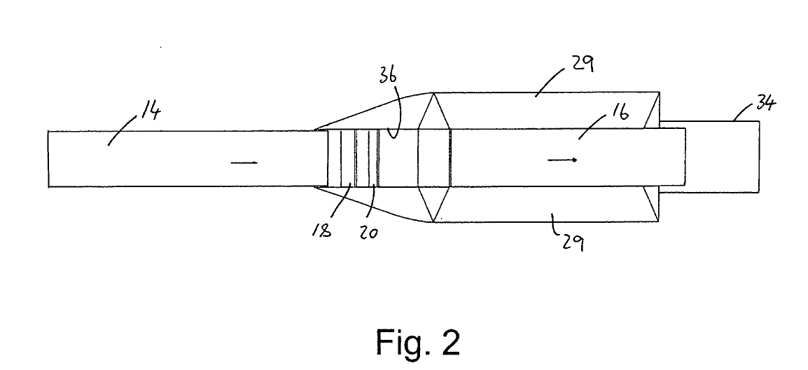

Referring to FIGS. 1 to 5 of the drawings, there is shown a contaminant removal device 10 for removing contaminants from contaminant laden target material when a significant proportion of the contaminants are more dense than the target material. In the present embodiment, the contaminant removal device 10 is described in relation to removal of contaminants from relatively loose fibrous plant material such as hay, although it will be understood that the contaminant removal device 10 may be used for removing contaminants from other plant material and indeed other non-plant material.

The device 10 includes a housing 12, means for causing contaminant laden target material to traverse an upwardly directed current of air, in this example in the form of a first conveyor 14 for conveying contaminant laden target material into the housing 12, and a second conveyor 16 for conveying separated target material away from the housing 12.

Disposed in the housing 12 are gas ejecting means, in this example in the form of first and second nozzles 18 and 20 respectively. The nozzles 18, 20 serve to eject a current of gas, in this example air, in an upwardly and forwardly direction such that air is forced through the contaminant laden material as the contaminant laden material enters the housing 12 via the first conveyor 14.

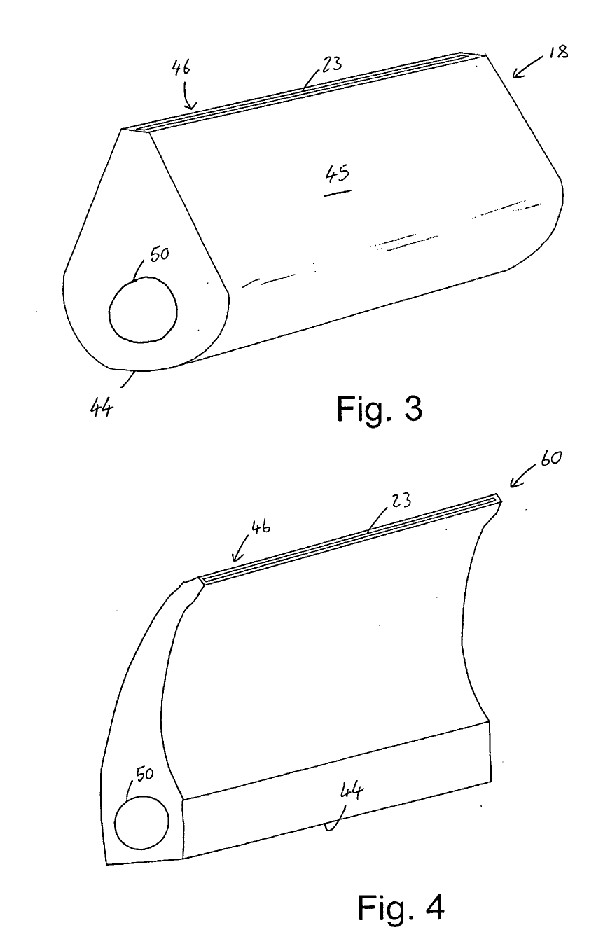

As shown more particularly in FIG. 3, in this example the first and second nozzles 18, 20 each include one outlet aperture 23 which in this example is of generally elongate configuration. The outlet apertures 23 of the first and second nozzles 18, 20 are oriented such that the outlet apertures extend in a direction generally perpendicular to the direction of travel of the contaminant laden material as it enters the housing 12.

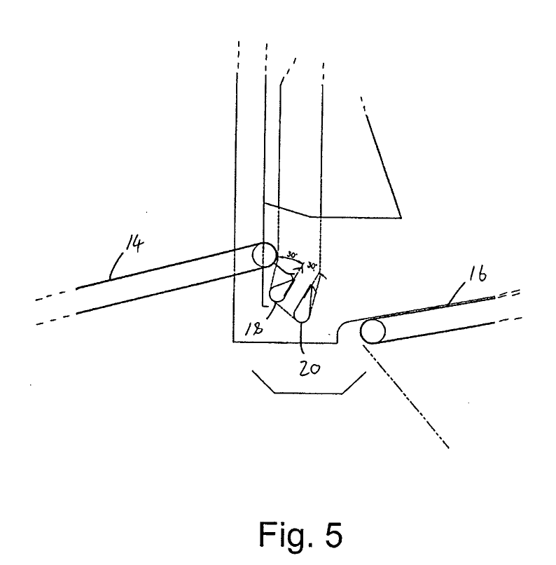

It will be understood that the first and second nozzles 18, 20 and, in particular, the outlet apertures 23 of the nozzles 18, 20 are arranged such that a distribution of upwardly and forwardly ejected air is created which minimises the amount of target material which falls downwardly under gravity past the nozzles 18, 20 during use. In this example, the first and second nozzles 18, 20 and the outlet apertures 23 of the first and second nozzles 18, 20 are arranged such that air ejected from the first and second nozzles 18, 20 travels in directions centred along lines extending approximately 30° from vertical, as shown more particularly in FIG. 5.

It will also be understood that the nozzles 18, 20 are arranged such that the second nozzle 20 is disposed slightly lower than the first nozzle 18. In the present embodiment, the outlet apertures 23 of the nozzles 18, 20 are located such that a line passing through the outlet apertures 23 subtends an angle of the order of 20°-30° to horizontal, in this example approximately 30° to horizontal.

It will also be understood that the configuration and orientation of the nozzles 18, 20 and the volume and speed of air ejected from the nozzles is such that the relatively less dense target material is provided with sufficient force to move forwardly and be prevented from moving downwardly relative to the nozzles, and such that the relatively more dense contaminants are not provided with sufficient force to move forwardly relative to the nozzles and instead move downwardly relative to the nozzles. The velocity of air ejected from the nozzles may be of the order of 20-30 m/s, in this example approximately 20 m/s. Also in this example, the volume of air ejected from the first and second nozzles 18, 20 is of the order of approximately 0.6 m³/s to 0.7 m³/s. However, it will be understood that the volume and velocity of air ejected from the nozzles 18, 20 is selected depending on the type of target and contaminant material concerned, the important aspect being that the air ejected by the nozzles causes the target material to be conveyed to a location remote from the nozzles, but is not sufficient to also convey the contaminant material and the contaminant material falls downwardly past the nozzles.

It will also be understood that disposing the nozzles 18, 20 such that each successive nozzle is lower than a preceding nozzle ensures that as contaminant laden material is conveyed into the housing 12, the target material is encouraged to continue to move forwardly, that is, away from the first conveyor 14.

Referring to FIG. 3, a nozzle 18, 20 is shown in more detail.

As can be seen in FIG. 3, the nozzle 18, 20 has a generally teardrop cross-sectional shape and includes a base portion 44, a side wall 45, and a nozzle portion 46 which define a chamber of reducing cross-sectional size from the base portion 44 to the nozzle portion 46. The nozzle 18 also includes an inlet aperture 50 which is connectable to a hose during use so that air forced during use through the hose passes into the nozzle chamber and out through the elongate outlet aperture 23.

In one arrangement, the length of each outlet aperture 23 is of the order of 1 m and the width of each aperture is of the order of 20 mm.

An alternative nozzle configuration is shown in FIG. 4. Like and similar features are indicated with like reference numerals. In this example, the nozzle 60 has a generally arcuate cross-sectional shape. However, it will be understood that any suitable nozzle configuration is envisaged.

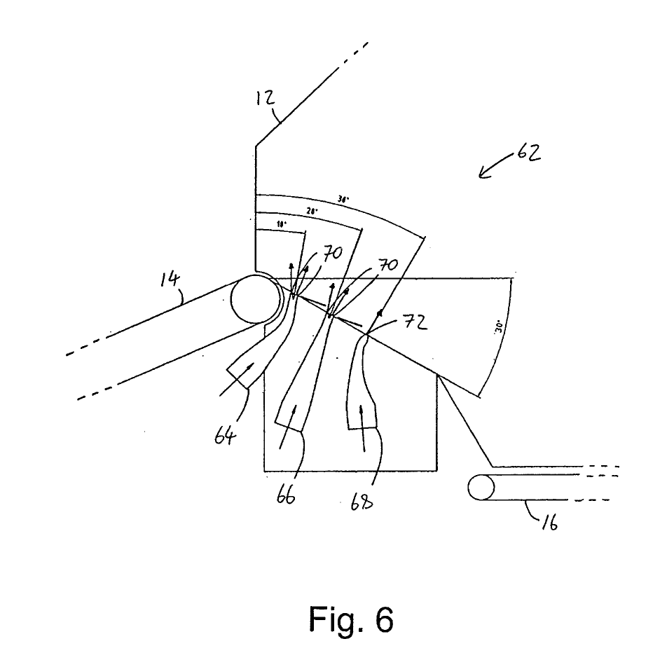

An alternative nozzle arrangement 62 is as shown in FIG. 6. The alternative nozzle arrangement 62 includes first, second and third nozzles 64, 66, 68. The first and second nozzles 60, 62 each include two outlet apertures 70 which in this example are of generally elongate configuration. The third nozzle 68 includes a single outlet aperture 72 which in this example is of generally elongate configuration. The outlet apertures 70, 72 of the first, second and third nozzles 64, 66, 68 are oriented such that the outlet apertures extend in a direction generally perpendicular to the direction of travel of the contaminant laden material as it enters the housing 12.

As with the nozzle arrangement shown in FIGS. 1 and 5, it will be understood that the first, second and third nozzles 64, 66, 68 and, in particular, the outlet apertures of the nozzles 64, 66, 68 are arranged such that a distribution of upwardly and forwardly ejected air is created which minimises the amount of target material which falls downwardly under gravity past the nozzles 64, 66, 68 during use. In this example, the first nozzle 64 and the outlet apertures 70 of the first nozzle 64 are arranged such that air ejected from the first nozzle 64 travels in directions centred along lines extending approximately 10° and 20° from vertical. The second nozzle 66 and the outlet apertures 70 associated with the second nozzle 66 are arranged such that air is ejected from the second nozzle 66 in directions centred along lines extending approximately 15° and 25° from vertical. The third nozzle 68 and the outlet aperture 72 associated with the third nozzle 68 are arranged such that air is ejected from the third nozzle 68 in a direction centred along a line extending approximately 30° from vertical.

It will also be understood that the nozzles 64, 66, 68 are arranged such that the second nozzle 66 is disposed slightly lower than the first nozzle 64 and such that the third nozzle 68 is disposed slightly lower than the second nozzle 66. In the present embodiment, the outlet apertures 70, 72 of the nozzles 64, 66, 68 are located such that a line passing through the outlet apertures 70, 72 subtends an angle of the order of 20°-30° to horizontal, in this example approximately 30° to horizontal.

The housing 12 includes an upper wall 24, a front wall 26, a rear wall 28 and side walls 29. The upper, front, rear and side walls 24, 26, 28 and 29 define a chamber 33 having a first outlet 34 through which target material passes during use, and a second outlet 36 through which contaminant material passes during use. The housing 12 is configured such that the size of the chamber 33 is sufficiently large to enable the target material entrained in the air from the nozzles to slow down enough to allow the target material fall onto the second conveyor 16, and sufficiently large so that turbulence inside the housing does not have an unduly negative effect on the performance of the device 10. In the present example, the size of a horizontal cross sectional area of the chamber is of the order of 10 m² and the housing 12 is configured such that the chamber 29 increases in size towards the upper wall 24. For example, the side walls 29 may be tapered so that the size of the chamber 33 gradually increases towards the upper wall 24.

It will be understood that during use as air is ejected from the nozzles 18, 20 a Venturi effect occurs which causes a reduction in pressure in a region of the chamber 33 generally below the outlet apertures 23, and that ejection of air from the nozzles 18, 20 causes an increase in pressure in a region of the chamber 33 generally above the outlet apertures 23. As a consequence, a pressure differential is created which tends to force air from the region of the chamber generally above the outlet apertures 23 to the region of the chamber 33 generally below the outlet apertures 23. In order to minimise disruption to satisfactory operation of the device 10 caused by such a pressure differential, a gas outlet 38 is provided in the upper wall 24 at a location adjacent the front wall 26, and the gas outlet 38 is connected to a region of the chamber generally below the outlet apertures 23 using a conduit 39. In this example, the conduit 39 includes an outlet fan 40 disposed adjacent the gas outlet 38 so as to encourage flow of air from the chamber 33 to the region of the chamber 33 generally above the outlet apertures 23. To further reduce the possibility of generation of a pressure differential, the region of the chamber generally below the outlet apertures is open to atmosphere. In the present example, the volume of air which is forced upwards and forwards by the Venturi effect is approximately 1.5 m³/s.

The device 10 may also include several fingers (not shown) extending generally between adjacent nozzles 18, 20, the fingers serving to restrict any relatively large target material which falls onto the fingers from falling downwardly towards the second outlet 36.

It will be appreciated that although the above example is described in relation to a device which includes a housing, this is not essential and the housing may be omitted if desired. However, by providing a housing, the level of dust present adjacent the device is minimised.

In operation, contaminant laden material is loaded onto the first conveyor 14 and is conveyed upwardly towards the housing 12. As the contaminant laden target material enters the housing 12, the target material experiences an upwardly and forwardly directed force by virtue of the forward momentum of the target material and in particular by virtue of the air ejected from the nozzles 18, 20. As a consequence, the target material is urged to move past the second outlet 36 by the ejected air and falls downwardly under gravity onto the second conveyor 16, and the target material falls onto the second conveyor 16 and is conveyed towards the first outlet 34.

At the same time as the target material is urged to move upwardly and forwardly, the contaminants, being too dense to be moved forwardly past the second outlet, fall downwardly under gravity past the nozzles 18, 20 and through the second outlet 36.

In other words, the nozzles serve to move the target material forwards and suspend the target material over the second outlet 36 for a sufficient period of time to allow contaminants entrained in the target material to fall.

Modifications and variations as would be apparent to a skilled addressee are deemed to be within the scope of the present invention.

1. A contaminant removal device for removing contaminants from contaminant laden target material when the contaminants are more dense than the target material, said device including:
a gas ejecting device for ejecting a current of gas in an upwardly and forwardly direction; and
means for causing contaminant laden target material to traverse the current of gas during use;
said gas ejecting device being arranged such that a substantial proportion of the target material is moved forwardly by said gas ejecting device to be disposed above a first location, and such that a substantial proportion of the contaminants does not move sufficiently forwardly to be disposed above the first location and falls downwardly towards a second location under action of gravity.

2. The device as claimed in claim 1, wherein the gas ejecting device includes at least one nozzle connectable, in use, to a source of gas.

3. The device as claimed in claim 2, wherein the or each nozzle includes at least one outlet aperture.

4. The device as claimed in claim 2, wherein at least one nozzle includes two or more outlet apertures.

5. The device as claimed in claim 3, wherein at least one outlet aperture is of generally elongate configuration with the outlet aperture disposed so as to extend in a direction generally perpendicular to the direction of travel of contaminant laden material during use.

6. The device as claimed in claim 2, further comprising a plurality of nozzles.

7. The device as claimed in claim 6, wherein the nozzles are arranged such that air ejected from the nozzles travels in directions centered along lines extending at angles to vertical which increase with each successive nozzle.

8. The device as claimed in claim 6, wherein the nozzles are disposed such that the or each outlet aperture of each nozzle is lower than the or each outlet aperture of a preceding nozzle.

9. The device as claimed in claim 6, wherein the outlet apertures of the nozzles are located such that a line passing through the outlet apertures subtends an angle of the order of 30° to horizontal.

10. The device as claimed in claim 1, wherein the means for causing the contaminant laden target material to traverse the current of gas during use comprises a conveyor belt.

11. The device as claimed in claim 2, wherein the or each nozzle is configured such that a nozzle chamber is defined for transferring gas between a gas source and the or each outlet aperture of the nozzle, the chamber reducing in cross-sectional area between the gas source and the or each outlet aperture.

12. The device as claimed in claim 1, further comprising a housing in which the gas ejecting device is disposed.

13. The device as claimed in claim 12, wherein the housing is configured such that during use the size of the housing is sufficiently large to minimise turbulence in the housing.

14. The device as claimed in claim 13, wherein the housing is arranged such that the cross-sectional size of the housing increases towards an upper wall of the housing.

15. The device as claimed in claim 12, further comprising a conduit connecting an upper portion of the housing to a region of the housing generally below the or each nozzle so as to thereby minimise generation of a pressure differential between a region of the housing generally above the or each nozzle and the region of the housing generally below the or each nozzle.

16. The device as claimed in claim 15, further comprising means for drawing gas through the conduit from the upper portion of the housing to the region of the housing generally below the or each nozzle.

17. A method of removing contaminants from contaminant laden material when the contaminants are more dense than the target material, said method including the steps of:
ejecting a current of gas in an upwardly and forwardly direction; and
causing contaminant laden target material to traverse the current of gas;
the step of effecting movement of contaminant laden target material causing a substantial portion of the target material to move forwardly to be disposed above a first location and causing a substantial proportion of the contaminants to not move sufficiently forwardly to be disposed above the first location and to fall downwardly towards a second location under action of gravity.

18. The method as claimed in claim 17, further comprising the step of ejecting the current of gas using at least one nozzle connectable, in use, to a source of gas.

19. The method as claimed in claim 18, further comprising the step of ejecting the current of gas using a plurality of nozzles.

20. The method as claimed in claim 19, further comprising the step of arranging the nozzles such that air ejected from the nozzles travels in directions centered along lines extending at angles to vertical which increase with each successive nozzle.

21. The method as claimed in claim 19, wherein each nozzle includes at least one outlet aperture, the method further comprising the step of disposing the nozzles such that the or each outlet aperture of each nozzle is lower than the or each outlet aperture of a preceding nozzle.

22. The method as claimed in claim 17, further comprising the step of causing the contaminant laden target material to traverse the current of gas using a conveyor belt.

23. The method as claimed in claim 17, further comprising the step of providing a housing in which the gas ejecting means is disposed.

24. The method as claimed in claim 23, further comprising the step of providing a conduit connecting an upper portion of the housing to a region of the housing generally below the or each nozzle so as to thereby minimise generation of a pressure differential between a region of the housing generally above the or each nozzle and the region of the housing generally below the or each nozzle.

25. The method as claimed in claim 24, further comprising the step of drawing gas through the conduit from the upper portion of the housing to the region of the housing generally below the or each nozzle.
